(19) United States
(12) Patent Application Publication
(10) Pub. No.: US 2023/0094193 A1
(43) Pub. Date: Mar. 30, 2023

(54) MULTI-POINT-CONTROLLED PELLET SMOKER AND GRILL

(71) Applicant: W.C. BRADLEY CO., Columbus, GA (US)

(72) Inventors: RAMIN KHOSRAVI RAHMANI, Columbus, GA (US); Alex Gafford, Midland, GA (US); BRUCE ROBERTS, Phenix City, AL (US); DAN CORSO, Columbus, GA (US); SLEIMAN ABDALLAH, Columbus, GA (US); ANTHONY HAMILTON, Hamilton, GA (US)

(21) Appl. No.: 17/947,289

(22) Filed: Sep. 19, 2022

Related U.S. Application Data
(60) Provisional application No. 63/246,268, filed on Sep. 20, 2021.

(51) Int. Cl. A47J 37/07

(52) U.S. Cl. CPC A47J 37/0704; A47J 37/0786

(57) ABSTRACT

A control system for a pellet fueled cooking device includes at least two adjustable smokestacks selectively allowing combustion gases to escape from a cooking chamber, and an air adjustment mechanism being adjustable between a first position where air flow into a firepot is substantially blocked and a second position where airflow into the firepot is allowed.

### CROSS-REFERENCE TO RELATED CASES

This application claims the benefit of U.S. Provisional Pat. Application Serial No. 63/246,268, filed on Sep. 20, 2021, and incorporates such provisional application by reference into this disclosure as if fully set out at this point.

### FIELD OF THE INVENTION

This disclosure relates to pellet smoker and grills in general and, more specifically, to systems and methods for controlling the operation of the same.

### BACKGROUND OF THE INVENTION

Current pellet smokers/grills in the market are controlled by an electro-mechanical system that uses one setpoint provided by the user and one data point in the form of measured temperature. The temperature measurement is usually taken by a probe placed above the cooking grate at the side wall of the cooking chamber. The fan used to provide combustion air for the pellets is normally operated at a fixed speed, and exhaust openings from the cooking chamber are of fixed size.

Single-point-controlled pellet smokers can provide a reasonable performance as long as the cooking chamber is relatively small, and the expected operation range is limited. For example, if a cooking appliance with limited volume is operated as a smoker producing a gas temperature of about 200 to 500° F. or higher, measuring gas temperature at one position can be fairly adequate for normal operation.

However, even relatively small single-point-controlled systems cannot precisely differentiate between situations in which the smoldering/combustion of the pellets in the firepot is running as expected or not. For instance, starting from cold and windy ambient conditions it may take an extended time for a temperature probe mounted above the cooking grate adjacent to the cooking chamber wall to register a rise in temperature. This may result in excessive amounts of fuel being introduced into the firepot, eventually resulting in an overshoot in the temperature of the cooking chamber. On the other hand, if the control system is tuned to pause feeding fuel into the firepot before the single probe can confirm the establishment of sustained fire, it can result in no fire and no heat. The restart process from this point can result in pellet overflows and/or delayed ignition events.

Limitations of single-point controlled systems become even more pronounced in units with larger volume and wider range of operations. As the volume of the cooking chamber increases, the natural temperature gradient inside that chamber increases. Thus a single temperature reading is even more likely to produce erroneous results. The same kinds of errors and resulting sub-optimal performance may also arise when a wider range of operational temperatures are desired. Higher temperatures generated by higher rate of heat input also contributes to higher temperature gradients in the system. In those devices expected to operate both as a smoker and a grill, relying on one measurement of the gas temperature inside the cooking chamber (if it were adequate for smoking) does not provide the suitable temperature measurements for grilling. The smoking process is mostly through the heat and smoke transfer from the hot gas resulted from smoldering of the pellets into the food, while the grilling process is mostly through the heat transfer from the hot cooking grate (via the combustion of pellets) into the food.

Single-point-controlled systems also lack a means for the user to fine-tune the temperature, or to create and control different temperature zones inside the same cooking volume as he/she would please.

What is needed is a system and method for addressing the above, and related, issues.

### SUMMARY OF THE INVENTION

The invention of the present disclosure, in one aspect thereof, comprises a control system for a pellet fueled cooking device having a cooking chamber with a cooking grate and a firepot below the cooking grate, the firepot fed fuel by an auger and fed air by plenum surrounding the firepot. The control system includes at least two adjustable smokestacks selectively allowing combustion gases to escape from the cooking chamber, the smokestacks having top caps that open to allow exhaust flow and close to block exhaust flow, and an air adjustment mechanism being adjustable between a first position where air flow into the firepot is substantially blocked and a second position where airflow into the firepot is allowed.

The control system may further comprise a plurality of temperature probes inside the cooking chamber and connected to an external display reporting the temperature sensed by each temperature probe. The plurality of temperature probes may comprise at least two temperature probes spaced apart and above the cooking grate and at least one temperature probe placed proximate the firepot. The external display may comprise a graphic display portraying the temperature and location of each of the plurality of temperature probes

In some embodiments, the system includes a plenum damper on the plenum adjustable between a first position where airflow into the plenum is substantially blocked and a second position where airflow into the plenum is allowed. An electrically powered fan may force air into the plenum when the damper is in the second position. The system may comprise a fan housing external to the plenum, the fan housing having a fan damper adjustable between a first position where air to the fan is substantially blocked and a second, open position.

According to some embodiments, the control system includes an electric actuator on each of the at least two adjustable smokestacks, the actuators opening and closing the top caps of the adjustable smokestacks. The system may comprise an electrical actuator that moves the air adjustment mechanism between the first and second positions thereof.

In some embodiments, the top caps of the at least two adjustable smoke stacks comprise an upper covering connected to a descending side skirt, and a pair of rings with cutouts within the side skirt, the rings being adjustable such that openings defined in each of the rings overlap when the top caps are open. The air adjustment mechanism may comprise a rotatable collar having cutouts that align with openings in the firepot when the rotatable collar is in the second position.

The invention of the present disclosure, in another aspect thereof, comprises a cooking system including a cooking chamber having a cooking grate and a pellet fueled firepot below the fuel grate, an electrically powered auger moving fuel pellets from outside the cooking chamber to the firepot, an air plenum delivering combustion air from outside the cooking chamber to the firepot from an outside of the firepot, a pair of exhaust openings spaced apart above the cooking grate, each of the pair of exhaust openings being adjustable to regulate a flow of exhaust gases out of the cooking chamber, an air adjustment mechanism surrounding the firepot and being adjustable to selectively impede air flow into the firepot from the plenum, at least two temperature probes reporting temperatures at spaced apart locations above the cooking grate to an external display, and at least one additional temperature probe proximate the firepot and reporting a temperature of the firepot to the external display.

The cooking system may include a processor computing an average temperature based on temperatures from the at least two temperature probes and reporting the same to the display. In some embodiments, the processor operates a pair of actuators connected to the pair of exhaust openings, respectively, to adjust exhaust flow from the cooking chamber. The processor may control an actuator connected to the air adjustment mechanism to selectively impeded the air flow into the firepot.

In some embodiments, a control panel allows a user to instruct the processor. The processor may control a speed of the electrically powered auger. The system may further include a fan delivering combustion air into the plenum under positive pressure, and a damper selectively blocking the flow of air from the fan into the plenum. The system may include a fan delivering combustion air into the plenum under positive pressure, a housing containing the fan and external to the planum, and a damper selectively blocking flow of air into the housing.

### BRIEF DESCRIPTION OF THE DRAWINGS

FIG. 1 is a frontal elevational view of a pellet smoker according to aspects of the present disclosure.

FIG. 2 is a frontal cutaway view of the cooking chamber of the pellet smoker of FIG. 1.

FIG. 3A is an inferior perspective view of a smokestack control according to the present disclosure.

FIG. 3B is an inferior perspective exploded view of the smokestack of FIG. 3A.

FIG. 4A is a frontal view of a smokestack control according to aspects of the present disclosure.

FIG. 4B is another frontal view of the smokestack control of FIG. 4A showing an adjustment from FIG. 4A.

FIG. 5A is a front cutaway view of a portion of a pellet smoker according to aspects of the present disclosure.

FIG. 5B is a perspective cutaway view of the pellet smoker of FIG. 5A.

FIG. 5C is an end perspective cutaway view of the pellet smoker of FIG. 5C.

FIG. 6 is a frontal view of a control panel for a pellet smoker according to aspects of the present disclosure.

FIG. 7 is a closeup view of an information display for a pellet smoker according to aspects of the present disclosure.

FIG. 8A is a cutaway perspective view of a firepot with air adjustment mechanism according to aspects of the present disclosure.

FIG. 8B is a closeup view of the firepot shown in FIG. 8A.

FIG. 8C is a closeup view of the firepot shown in FIG. 8B with an airflow adjustment made.

FIG. 9A a is a cutaway perspective view of an air conduit according to aspects of the present disclosure with a downstream damper.

FIG. 9B is another cutaway perspective view of the air conduit of FIG. 9A with an adjustment made to the downstream damper.

FIG. 10A is a cutaway perspective of an air conduit according to aspects of the present disclosure with an upstream damper.

FIG. 10B is a cutaway perspective view of the air conduit of FIG. 10A with an adjustment made to the damper

FIG. 10C is a cutaway perspective view of the air conduit of FIG. 10A with a further adjustment made to the damper.

FIG. 11 is a plan view of a control panel and display for a pellet smoker according to aspects of the present disclosure.

FIG. 12 is a simplified schematic diagram of a pellet smoker according to aspects of the present disclosure.

### DETAILED DESCRIPTION OF THE PREFERRED EMBODIMENTS

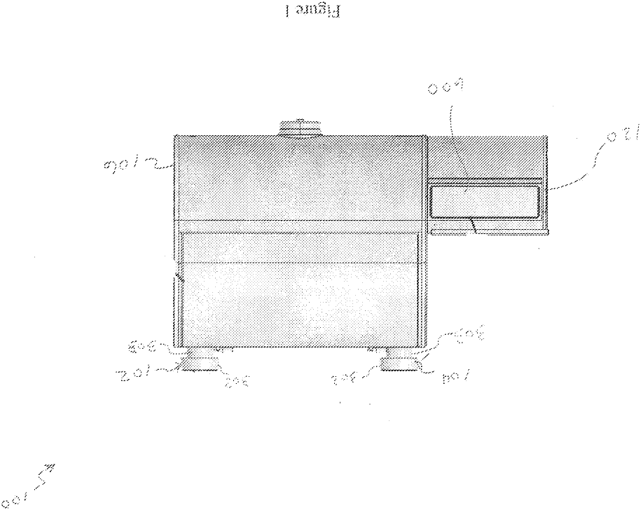

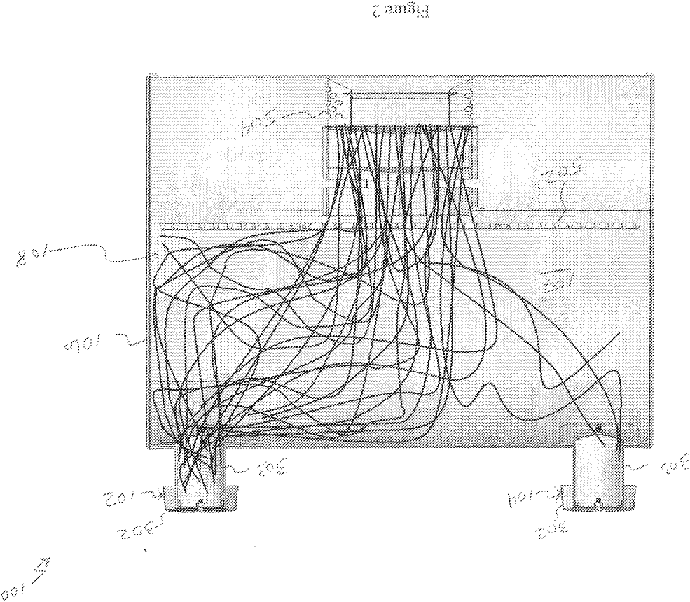

Referring now to FIG. 1, a pellet smoker/grill 100 equipped with two adjustable smokestack assemblies 102, 104 is shown. The smokestack assemblies may comprise an adjustable top cap 302 covering a flue pipe 303 or exhaust gas pipe. The smokestack assemblies 102, 104 may be placed on or near the top of a cooking chamber 106, and may be at opposite ends of the cooking chamber 106. As can be seen in FIG. 2, the cooking chamber 106 may define an interior volume 107 containing a cooking grate 502 and a heat or combustion source such as a pellet fueled firepot 504. The smokestack assemblies 102, 104 allow smoke and combustion gases to escape from the interior volume 107, but may be open, closed, or adjusted to fine tune gas flow inside the cooking chamber 106 (e.g., within interior volume 107).

In some embodiments, a greater number of smokestack assemblies may be used, particularly if the cooking chamber 106 is particularly large. However, even two smokestack assemblies 102, 104 allow both fine tune temperatures inside the cooking chamber 106 zonal temperate control and cooking conditioning.

One of many possible scenarios is shown in FIG. 2, where two smokestack assemblies 102, 104 are adjusted such that the right smokestack 102 is open to a greater degree than the left smokestack 104 such that a higher portion of the smoke and gas 108 in the cooking chamber 106 flows towards the right side of the cooking chamber 106. This operation and similar ones may be affected by adjustment of the top caps 302 on the respective exhaust flue pipes 303 as described below.

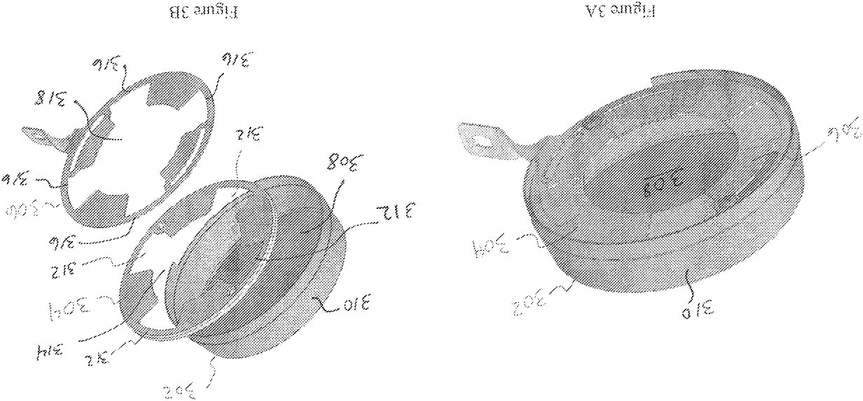

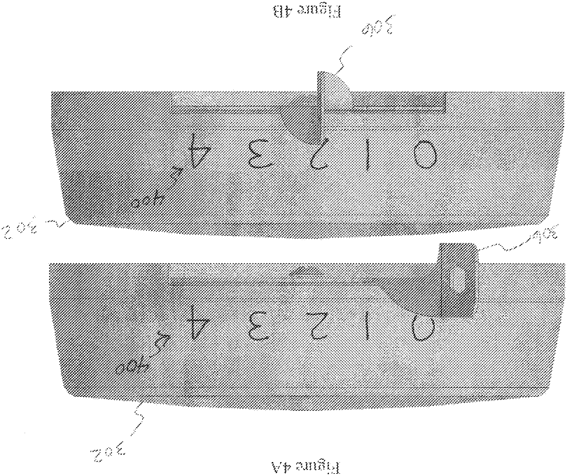

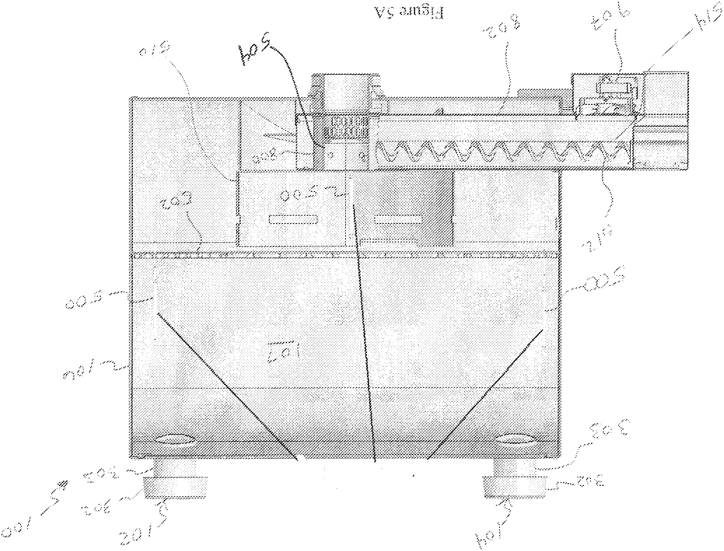

FIGS. 3-4B illustrate one possible construction for the top caps 302 as may be utilized to provide flow adjustment of smokestack assemblies 102,104. Top cap 302 may prevent penetration of rainwater into the cooking chamber 106 and diminishes any negative impact of the side wind trying to enter the cooking chamber 106. In this respect, the top cap 302 may comprise an upper covering 308 and a downwardly descending side skirt 310.

The top caps 302 may comprise a middle disk 304 defining a set of openings or cutouts 312 around a central opening 314. The middle disk 304 may be stationary and attached to the top cap cover 302. In some embodiments, the middle disk 304 attaches to the side skirt 310. A rotary lower disk 306 may define a set of openings or cutouts 316 around a central opening 318. Rotation of the lower disk 306 may be used to adjust from a full open setpoint (when the cutouts 312, 316 of both disks 304, 306, respectively, are aligned) to a full closed setpoint (when the cutouts 312, 316 do not overlap) or any configuration between. In some embodiments, the middle disk 304 is fixed to the flue pipe 303. The circular cutouts 314, 318 of the disks 304, 306, respectively, allow the caps 302 receive exhaust or cooking gases such outflow is controlled by adjustment of the lower disk 306.

As best seen in FIGS. 4A-4B, the top caps 102, 104 are adjustable externally and may provide indices 400 for a user to see at a glance the degree of opening or closure the respective top cap 302 is providing.

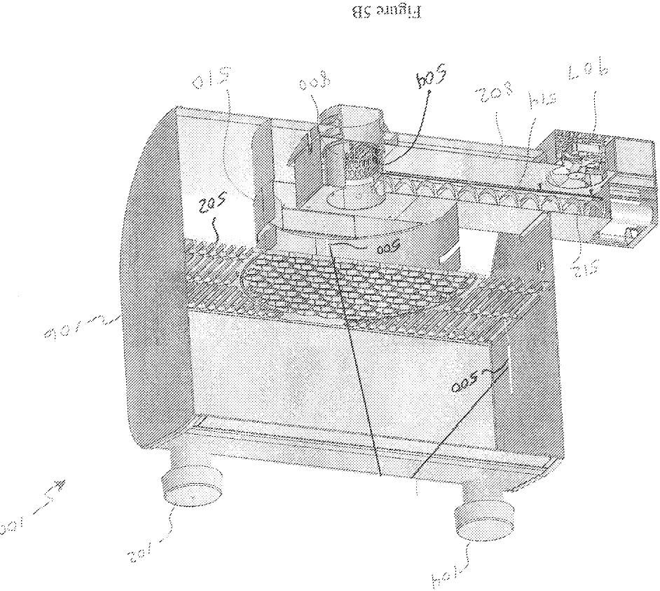

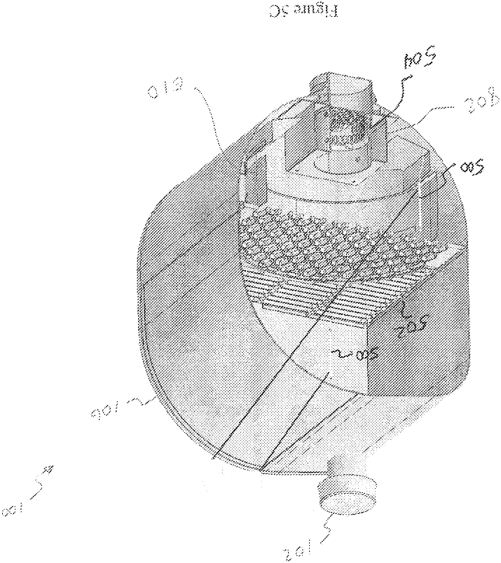

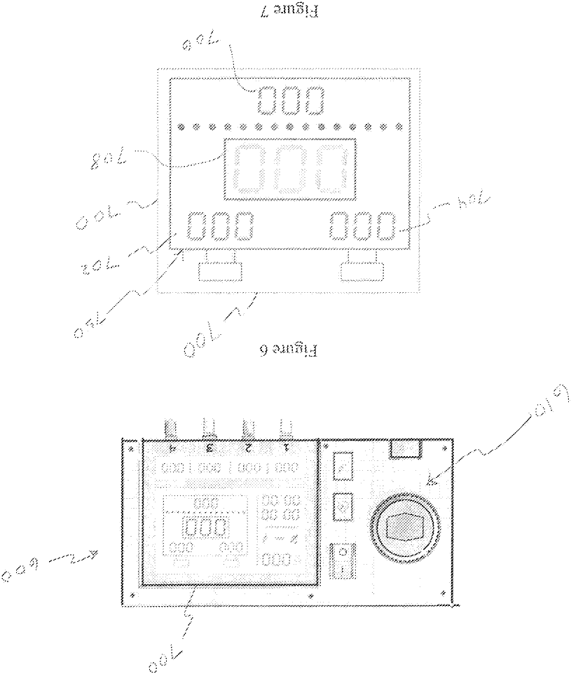

Referring now to FIG. 5A a front cutaway view of a portion of a pellet smoker/grill 100 according to aspects of the present disclosure is shown. FIG. 5B is a perspective cutaway view of the pellet smoker 100 and FIG. 5C is an end perspective cutaway view of the same. The pellet smoker/grill 100 may have an internal firepot 504 configured to burn pelletized fuel delivered via an electrically powered auger 512 in an auger tube 514. Here, operation of the auger 512 may be controlled as described below, based on feedback from various temperature sensors 500.

Fuel pellets are selectively delivered via operation of an electric motor attached to the auger 512 moving fuel pellets from a hopper external to the cooking chamber 106 (for example, from the pellet hopper 120). An air plenum 802 may travel from an external air supply to surround an outer portion of the firepot 504 to deliver combustion air. In some embodiments, the auger tube 514 and auger 512 travel from the hopper 120 through the air plenum 802 to the firepot 504. Air to the firepot 504 may be provided under positive pressure from an electric fan 907.

Multiple temperature sensors 500 may be positioned above and below a cooking grate 502, near the center and near the perimeters of the cooking chamber 106. Temperature sensors 500 may sense and differentiate the gas temperature at different regions of the cooking chamber 106, cooking grate 502 temperature, and the temperature of the combustion products at a firepot 504 (either from direct readings or via calculations from the measured values). This exemplary configuration allows for zonal, real-time temperature information inside the cooking chamber 106, and provides any associated control or sensing system with real-time temperature feedback of not only cooking area but also the heat source.

In other embodiments, locations of the sensors 500 may vary from that shown. A temperature sensor may be utilized at any location from which temperature data would be useful. Additionally, more or fewer sensors 500 may be used, depending upon need and size of the cooking chamber 106 or other components. It should be noted that any temperature probe 500 intended to monitor the heat source is not necessarily inside the heat source (firepot 504) but may be located above or adjacent thereto. Such probe can be placed sufficiently close to the firepot 504 to read, infer, or calculate its temperature without being subj ect to unnecessarily high heat inside the firepot 504 itself. In some embodiments, an internal diffuser 510 surrounds the firepot 504. A temperature probe 500 may be placed on the diffuser 510 (inside or outside) to provide relevant temperature or data with respect to the firepot 504.

Temperature probes 500 may be, but are not limited to, a thermocouple or a RTD (resistance temperature detector), an ultra-violet flame sensor, a flame ionization sensor, an oxygen sensor or oxygen depletion sensor, and/or another chemical signature sensor.

In other embodiments, for a system that preserves symmetry both in physics and geometry, one of the temperature probes at one of the side walls can be used to measure and provide the temperature value at both sides of the smoker/grill (allowing for 2-point temperature measurements). For purposes of the present disclosure, use of the term “symmetry” signifies that the cooking appliance is sufficiently physically similar from one side to another (e.g., side to side and/or front to back) and heating operations are supplied such that a temperature at one point inside the appliance may be reasonably certain to be substantially the same as the same point on the opposite side. Similarly, where the appliance is substantially symmetrical with respect to physics and geometry, a single temperature probe may be sufficient to predict, or provide data for predictions of, multiple temperatures in different locations. For example, a temperature taken at various locations on the cooking grate 502 may be suitable for inferring temperatures at other locations on the grate or elsewhere within a cooking device according to the present disclosure.

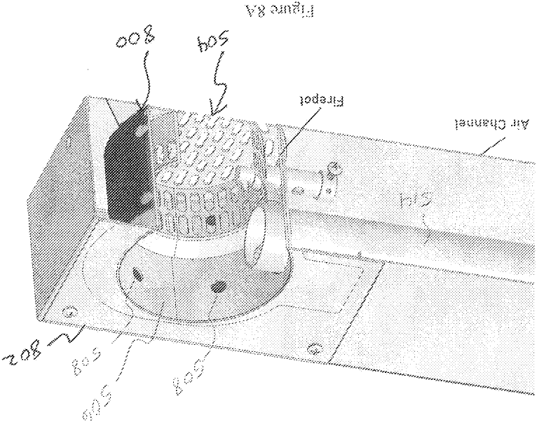

Referring now to FIG. 6, a frontal view of a control system 600 for a pellet smoker according to aspects of the present disclosure is shown. The control system 600 may provide controls 610 for operation of a pellet grill or smoker as are known in the art. An information display 700 may be utilized to provide control data as gathered by the various temperature probes.

FIG. 7 is a closeup view of an associated information display 700 for a pellet smoker according to aspects of the present disclosure. In some embodiments, the control system 600 allows more precise control of cooking operation for the user by displaying temperature data obtained by the sensors 500. In the illustrated example, sub-display 702 displays measured temperature on the right side of the cooking chamber 106, and sub-display 704 displays measured temperature on the left side of the cooking chamber 106. Temperature at or near the firepot 504 may be displayed on sub-display 706, while a calculated averaged chamber temperature may be shown in sub-display 708. The sub-displays 702, 704, 706, 708 may be arranged on a graphic 750 representing the cooking chamber 106 and showing the temperatures at the approximate actual locations of the respective temperature probes 500 inside the cooking chamber 106. The display 700 may also be configured to display temperature from meat probes (if utilized).

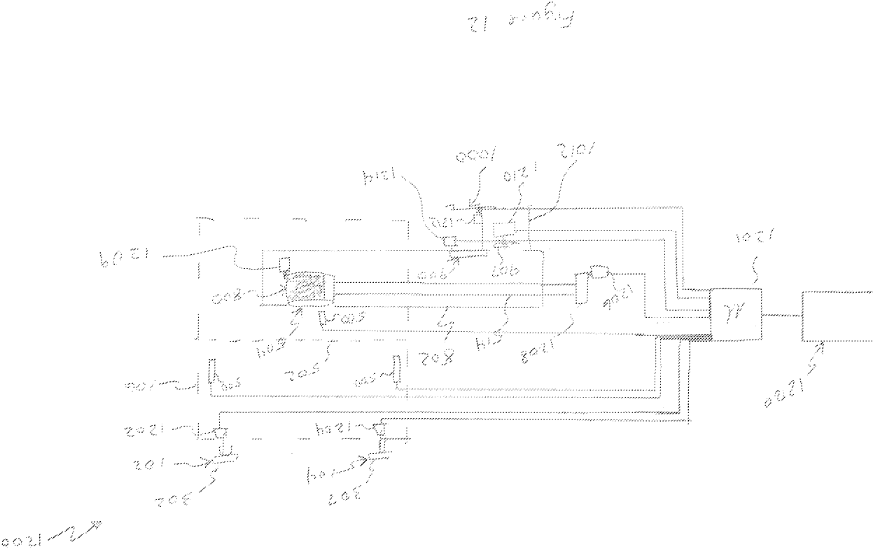

Referring now to FIG. 11, another embodiment of a control system 1100 is shown. This may be used in place of the control system 600 in any embodiment herein. A main power button 1104 may be provided as well as a temperature dial 1102. Selection between grilling and smoking operations may be made via button 1108. One or more meat probes may be activated or read by use of button 1110. Timer functions may be executed using button 1112. A shutdown button 1106 may cause the fuel supply to be stopped while fuel remaining in the firepot 504 is allowed to complete combustion.

A multi-information display 1114 may be provided giving information related to temperatures sensed by probes 500. Without limitation this display 1114 may provide a temperature probe readout 1120 giving information related to each probe present (e.g., probes 500, meat probes, or other). A set temperature may be shown in readout 1122 while an average computed temperature may be provided at readout 1124. Timer information may be provided on readout 1126. Alternatively, the air/smoke temperature may be shown in readout 1122 while the cooking grate temperature may be provided at readout 1124. Depending on the cooking mode chosen by the user, the displays might switch between the values of air/smoke and cooking grate temperature.

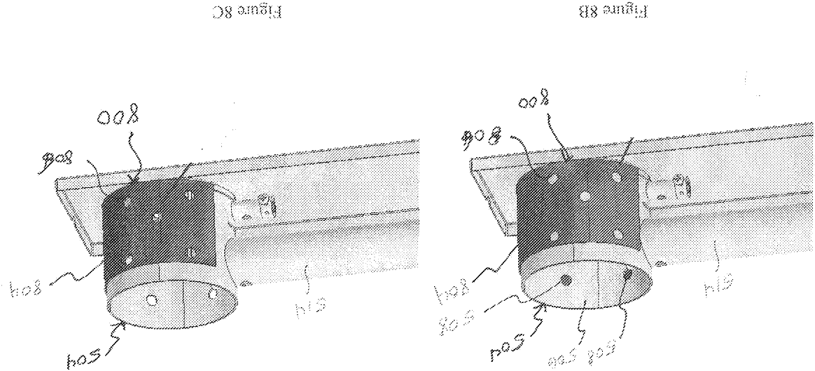

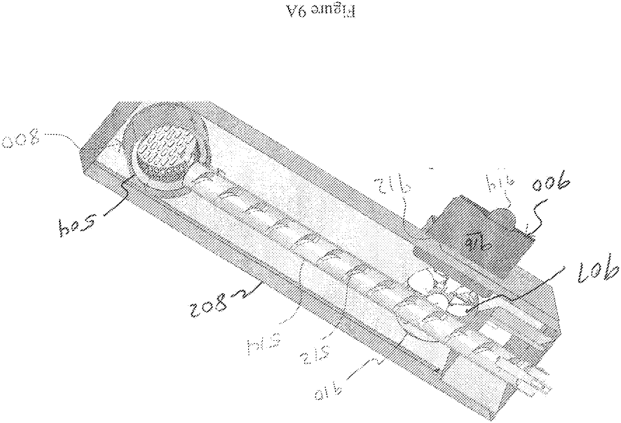

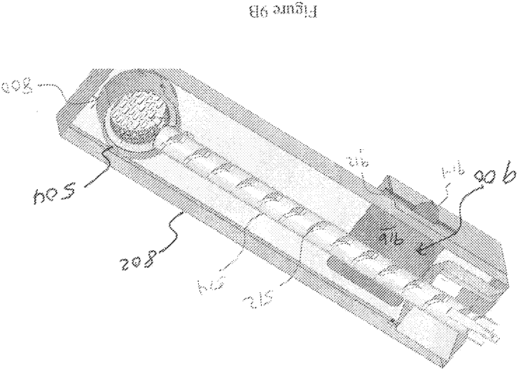

Referring now to FIGS. 8A-10C, an additional mechanism to control the air supplied into the firepot 504 (e.g., apart from operation of the fan 907) is shown. FIG. 8A is a cutaway perspective view of a firepot 504 with air adjustment mechanism 800 according to aspects of the present disclosure. FIG. 8B is a closeup view of the firepot 504 with the air adjustment mechanism 800 closed or substantially closed; and FIG. 8C is a closeup view of the firepot 504 with the air adjustment mechanism 800 open or substantially open.

The firepot 504 may comprises an outer wall 506 having a number of air openings 508 defined therein for admitting combustion air from the plenum 802. The wall 506 may be cylindrical and may be surrounded by a rotatable collar 804 comprising the adjustment mechanism 800. The collar 804 may be a cylindrical or comprise a segment of a cylinder that can move rotatably along an outside of the wall 506. The collar 804 may define a number of openings 806 that correspond to the openings in the wall 506. The collar 804 may be rotated such that the openings 508, 806 are not aligned, as in FIG. 8B, thereby blocking or impeding airflow into the firepot 504. The collar 804 may also be rotated such that the openings 508, 806 are aligned or substantially aligned for maximum combustion airflow from the plenum 802. The collar 804 may also be rotated such that openings 508, 806 are partially aligned for a reduced airflow. In another embodiment, the collar 804 is arranged to be inside the firepot 504, with the same or a similar arrangement between openings 508, 806 to allow or block airflow.

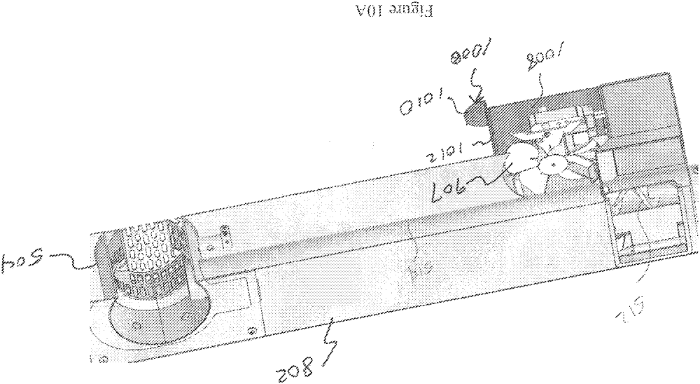

Referring now to FIG. 9A, a cutaway perspective view of the air plenum 802 is shown. Here another control mechanism in the form of a damper 900 is provided. The fan 907 may be arranged to force air into the plenum 802 via opening 910. The damper 900 may comprise a panel 916 that is movable to cover, uncover, or partially cover the opening 910 to reduce the amount of air entering the plenum even if/when a speed of the fan 907 is not adjusted or not adjustable. The panel 916 may slide from outside the plenum 802 to inside the plenum 802 to cover or uncover the opening 810 through a slot 912 in the plenum 802. A handle 914 may allow sliding of the panel 816 from outside the plenum 802. FIG. 9B is another cutaway perspective view showing the damper 900 in a fully closed position.

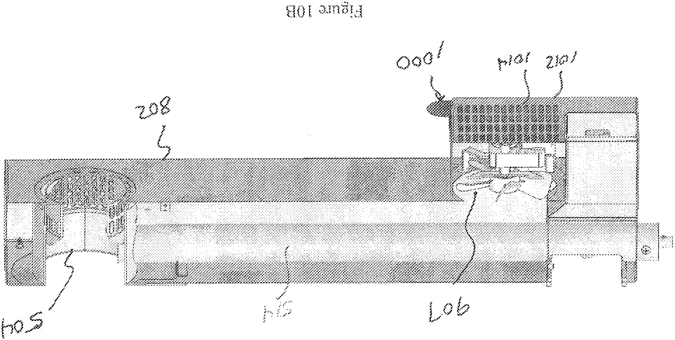

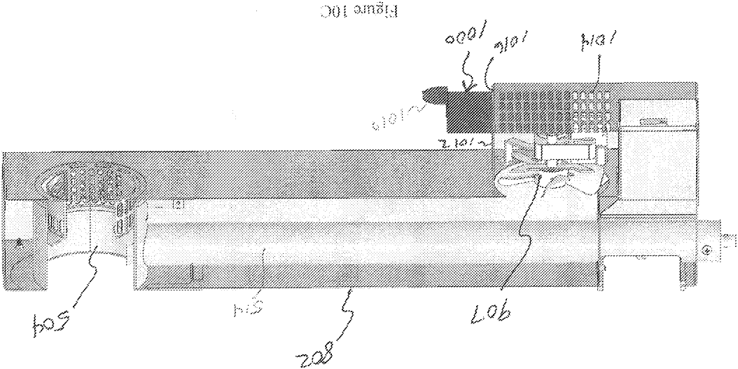

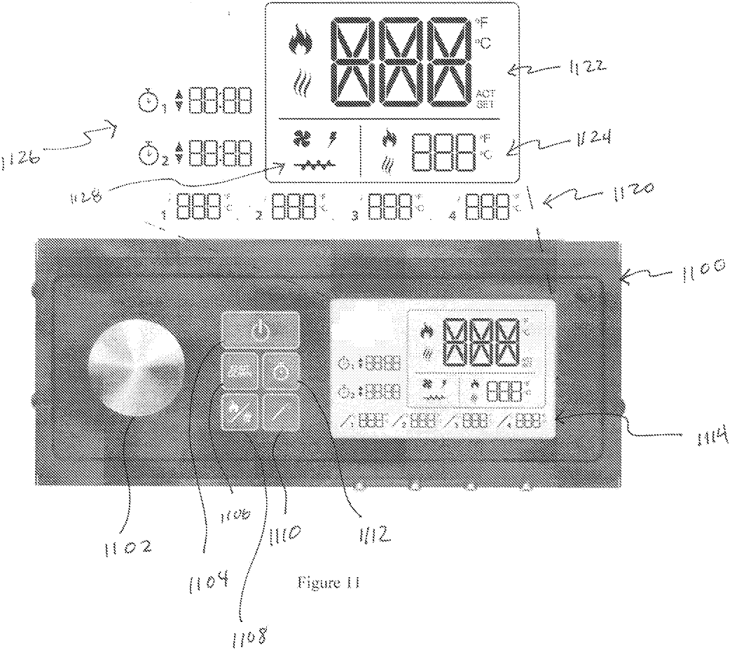

Referring now to FIG. 10A is a perspective cutaway perspective of the plenum 802 is shown. FIG. 10A and FIG. 10B are inferior cutaway perspective views of the same. FIGS. 10A-10C illustrate another control mechanism in the form of an intake damper 1000. Intake damper 1000 may limit or block airflow into a fan housing 1012 prior to the combustion air reaching the fan 907 for forcing into the plenum 802. A screen or openings 1014 may be defined near the fan 907 in the housing 1012. The damper 1000 may comprise a panel 1008 that can be moved to open, close, or partially close off the openings 1014 from airflow. The panel 1008 may insert into the housing 1012 via a slot 1016 in the housing adjacent to the openings 1014 and have an external handle 1010 for manual manipulation of the damper 1000.

The dampers 800, 900, 1000, as well as the caps 302 may also be adjusted manually. A user may adjust these items for controlling or equalizing the temperatures inside cooking chamber 106 based on information provided, for example, on the display 700. In further embodiments, dampers 800, 900, 1000, and/or caps 302 may be adjusted using servos, electric motors, or actuators. FIG. 12 provides a simplified schematic diagram of such a system 1200. FIG. 12 does not necessarily represent physical wiring, but logical control connections. Power connections and wiring techniques, as may be known in the art, are not shown for clarity. Physically, but for the additions of the actuators and control connections as shown herein, the grill/smoker system 1200 may be substantially similar to the system 100 described above.

In some embodiments, the grill/smoker system 1200 is based on use of a microcontroller 1201. In other embodiments, a microprocessor or other silicon-based controller and/or circuit may be used. Control methods may be programmed or provided in firmware. The microcontroller 1201 is communicatively coupled to a control panel 1220. Physically, the control panel may resemble the control system 600 discussed above. The control panel 1220 may provide various display screens (e.g., such as information display 700) and necessary knobs, sliders, buttons, and/or switch gear to control operation of the grill/smoker 1200 and all of its functions.

An actuator 1202 may be configured to adjust the cap 302 of the smokestack 102 and an actuator 1204 may be configured to adjust the cap 302 of the smokestack 104 (additional actuators may be deployed if there are additional smokestacks). According to the present disclosure, the actuators may be electric motors (DC or AC), servos, or electrically powered linear actuators. Actuators may be affixed to the relevant control item via a toothed interface, reduction gearing, or other means known to the art.

An actuator 1209 may be configured to rotate adjustment mechanism 800 controlling air flow into the firepot 504. An actuator 1212 may control the position of damper 1000 and/or an actuator 1214 may control position of the damper 900. All actuators may be controlled by microcontroller 1201.

The microcontroller 1201 may also directly control an electric motor 1206 operating the auger 512 feeding fuel into the firepot 504. In some embodiments, the motor 1206 connects to the auger 512 via a gear set 1208. An electric motor 1210 driving the fan 907 may also be controlled by the microcontroller. The motors 1206, 1210 may be AC or DC fans. These may also be variable speed motors whose speed is controlled by the microcontroller 1201 to control fuel and air supply. In some embodiments, the motors 1206, 1210 may be single speed devices that are operated intermittently to achieve a similar effect to a variable speed motor.

The microcontroller 1201, via connection to the temperature probes 500, can differentiate among the gas temperatures inside the cooking chamber 106 (measured in different areas of the large chamber), cooking grate 502, and the firepot 504. Executed control methods can deliver a precisely desired performance across a wide range of temperatures and conditions for the pellet smoker/grill 1200. The same performance may be achieved by manual operation of the controls based on information provided by the control system 600 for the grill/smoker 100.

The following is a non-exclusive list of the benefits and operations available according to the present disclosure: monitor the firepot 504 temperature as the grill/smoker 100/1200 is started from typical or extreme cold ambient to exactly determine when the combustion is established; compare the smoke setpoint with the temperatures of the firepot 504 and the cooking chamber 106 to precisely heat up the cooking chamber 106 to the targeted set-point with diminished overshoot or undershoot with shortest possible warmup time; monitor and compare the smoke setpoint with the temperatures of respective areas of cooking chamber 106 to maintain a temperature at the targeted setpoint with minimal oscillations; monitor the temperature of firepot 504 to prevent and /or report any flame out or delayed ignition; monitor the firepot 504 temperature as the unit 100 is set to cool smoking in an extreme warm ambient to prevent the system 100 from either running with no pellets or the flame going out; when grilling, compare the grill 100 setpoint with the temperatures of the firepot 504 and the cooking grate 502 to precisely heat up the cooking grate 502 to the targeted set-point with diminished overshoot or undershoot with shortest possible warmup time; monitor and compare the grill 100 setpoint with the cooking grate 502 temperature to maintain the temperature at the targeted setpoint with minimal oscillations; and, monitor the temperature of firepot 504 to prevent any flame out or delayed ignition.

Grills/smokers of the present disclosure can provide different cooking modes at low to mid temperatures. If the consumer prefers to smoke at low to medium temperature, the system (e.g., 100/1200) maintains the temperature by adjusting the rate of fuel supply, while providing the air supply with a rate appropriate for smoldering of the pellets in order to generate sufficient smoke. If the consumer prefers to bake rather than smoke at low to medium temperature, the system (e.g., 100/1200) readjusts the rates of fuel of air supply in a manner to maintain the temperature at the desired setpoint, while preventing the pellets from smoldering and diminishing the smoke.

It should be understood that the necessary control logic and circuitry to accomplish the tasks outlined above are contemplated by the present disclosure as may be constructed and arranged by one of skill in the art. It should also be understood that control functions and features provided by the devices of the present disclosure may be made available by remote control (connected by e.g., IR, Bluetooth®, Wi-Fi, cellular, or another communications link). A separate wireless remote replicating control functions may be provided as a component of a system according to aspects of the present disclosure. In some embodiments, control may be provided via a phone app or website. It is understood that, in some embodiments, controls available at the remote (whether physical or via an app) may comprise a subset or a superset of the full control operations available at the cooking device itself.

Systems and methods of the present disclosure offer at least one or more of the following benefits: more accurate determination and control of the temperature inside the cooking volume 106 by using multiple data points, which enhances the performance of the unit 100 for a wide-range-temperature operation in smoking mode; providing more convenient, more intuitive, and more precise smoking and grilling experiences by differentiating the gas temperature inside the cooking chamber 106 from the cooking grate 502 temperature; preventing temperature overshoots and undershoots as well as delayed ignition and pellets overflow by differentiating the gas temperature inside the cooking chamber 106 from the temperature of the combustion products inside the firepot 504; and allowing for fine-tuning the temperature inside the cooking chamber 106 and/or creating desired temperature zones and/or smoke patterns by having multiple adjustable smokestacks 102/104 that are paired with dedicated temperature probes 500.

The cooking devices of the present disclosure (e.g., 100, 1200) may be utilized in a number of cooking modes. In a first mode of operation fuel is burned at least some time at a first higher temperature to reduce smoke. Such mode may be considered a baking mode. In a second mode of operation fuel is burned at least some time at a second lower temperature to increase smoke production. Such mode may be considered a smoking mode. Various grilling modes and mixed modes of operation may be conducted as well.

According to various embodiments of the present disclosure, systems may have multiple components that may bear directly on control aspects. These include, without limitation, adjustable smokestacks 102, 104, a series of temperature probes 500 positioned above and below the cooking grates 502 inside the cooking volume 107. A control system may provide multiple data points and use multiple data points to manage the operation of the system according to the desired setpoints. Additionally, an adjustable air supply system that controls the supplied air provided to the pellet fuel inside the firepot may be utilized as shown herein.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number) - (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7 -91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A control system for a pellet fueled cooking device having a cooking chamber with a cooking grate and a firepot below the cooking grate, the firepot fed fuel by an auger and fed air by plenum surrounding the firepot, the control system comprising:
at least two adjustable smokestacks selectively allowing combustion gases to escape from the cooking chamber, the smokestacks having top caps that open to allow exhaust flow and close to block exhaust flow; and
an air adjustment mechanism being adjustable between a first position where air flow into the firepot is substantially blocked and a second position where airflow into the firepot is allowed.

2. The control system of claim 1, further comprising, a plurality of temperature probes inside the cooking chamber and connected to an external display reporting the temperature sensed by each temperature probe.

3. The control system of claim 2, wherein the plurality of temperature probes comprises at least two temperature probes spaced apart and above the cooking grate and at least one temperature probe placed proximate the firepot.

4. The control system of claim 3, further comprising a plenum damper on the plenum adjustable between a first position where airflow into the plenum is substantially blocked and a second position where airflow into the plenum is allowed.

5. The system of claim 4, further comprising an electrically powered fan forcing air into the plenum when the damper is in the second position.

6. The system of claim 5, further comprising a fan housing external to the plenum, the fan housing having a fan damper adjustable between a first position where air to the fan is substantially blocked and a second, open position.

7. The system of claim 1, further comprising an electric actuator on each of the at least two adjustable smokestacks, the actuators opening and closing the top caps of the adjustable smokestacks.

8. The system if claim 1, further comprising an electrical actuator that moves the air adjustment mechanism between the first and second positions thereof.

9. The system of claim 2, wherein the external display comprises a graphic display portraying the temperature and location of each of the plurality of temperature probes.

10. The system of claim 1, wherein the top caps of the at least two adjustable smoke stacks comprise an upper covering connected to a descending side skirt, and a pair of rings with cutouts within the side skirt, the rings being adjustable such that openings defined in each of the rings overlap when the top caps are open.

11. The system of claim 1, wherein the air adjustment mechanism comprises a rotatable collar having cutouts that align with openings in the firepot when the rotatable collar is in the second position.

12. A cooking system comprising:
a cooking chamber having a cooking grate and a pellet fueled firepot below the fuel grate;
an electrically powered auger moving fuel pellets from outside the cooking chamber to the firepot;
an air plenum delivering combustion air from outside the cooking chamber to the firepot from an outside of the firepot;
a pair of exhaust openings spaced apart above the cooking grate, each of the pair of exhaust openings being adjustable to regulate a flow of exhaust gases out of the cooking chamber;
an air adjustment mechanism surrounding the firepot and being adjustable to selectively impede air flow into the firepot from the plenum;
at least two temperature probes reporting temperatures at spaced apart locations above the cooking grate to an external display; and
at least one additional temperature probe proximate the firepot and reporting a temperature of the firepot to the external display.

13. The cooking system of claim 13, further comprising a processor computing an average temperature based on temperatures from the at least two temperature probes and reporting the same to the display.

14. The cooking system of claim 13, wherein the processor operates a pair of actuators connected to the pair of exhaust openings, respectively, to adjust exhaust flow from the cooking chamber.

15. The cooking system of claim 15, wherein the processor controls an actuator connected to the air adjustment mechanism to selectively impeded the air flow into the firepot.

16. The cooking system of 16, further comprising a control panel allowing a user to instruct the processor.

17. The cooing system of claim 16, wherein the processor controls a speed of the electrically powered auger.

18. The cooking system of claim 13, further comprising:
a fan delivering combustion air into the plenum under positive pressure;
a damper selectively blocking the flow of air from the fan into the plenum.

19. The cooking system of claim 13, further comprising:
a fan delivering combustion air into the plenum under positive pressure;
a housing containing the fan and external to the planum; and
a damper selectively blocking flow of air into the housing.
